(19) United States
(12) Patent Application Publication
(10) Pub. No.: US 2026/0063149 A1
(43) Pub. Date: Mar. 5, 2026

(54) Venturi Powder Pump and Coating Installation Comprising Such a Powder Pump

(71) Applicant: EXEL INDUSTRIES, Epernay (FR)

(72) Inventors: Franck Charlon, Epernay (FR); Maxime Perrier, Epernay (FR)

(21) Appl. No.: 19/311,872

(22) Filed: Aug. 27, 2025

(30) Foreign Application Priority Data
Aug. 28, 2024 (FR) 2409179

(51) Int. Cl. F04F 5/20; B05B 7/14; F04F 5/44; F04F 5/54

(52) U.S. Cl. CPC F04F 5/20; B05B 7/1468; B05B 7/1472; F04F 5/44; F04F 5/54

(57) ABSTRACT

The present invention relates to a Venturi powder gun comprising a body, an injector of drive gas and an ejector of a mixture comprising the powder product, mounted in the body. The body defines a duct for circulating the mixture, upstream of the ejector. The injector and the ejector are straight and extend respectively along an injector axis and an ejector axis, which coincide when the powder pump is in the assembled configuration. Means for indexing the position of the ejector within the pump body, in rotation about the ejector axis, make it possible to align an inlet of a suction chamber with the mixture circulation duct defined by the pump body.

### CROSS-REFERENCE TO RELATED APPLICATIONS

This application claims priority to French Application No. 2409179, filed on Aug. 28, 2024, which are incorporated herein by reference in its entirety.

### FIELD OF THE INVENTION

This invention relates to a Venturi powder pump and to a powder coating installation comprising, among other things, such a powder pump.

### BACKGROUND

In the field of powder coating installations, a Venturi powder pump is known to be used to convey a mixture of gas and coating drawn from a reservoir to a coating sprayer positioned close to the parts to be coated.

The function of a Venturi powder pump is to suck the powder coating into the reservoir, this coating preferably being fluidised by the addition of a fluidising gas, by means of a porous plate located at the bottom of the reservoir. The Venturi pump propels the mixture of gas and coating to the sprayer, which can also be referred to as the applicator. The performance and consistency of a Venturi pump derive from the combination of two parts: an injector for the drive gas, which is usually air, and an ejector for the mixture comprising the powdered product and the drive gas. The injector is designed to inject drive gas at high velocity into a suction chamber of a pump casing where it expands. The expansion of the drive gas generates a vacuum in the suction chamber, allowing the powder coating to be sucked through a duct defined by the pump body, which is connected to the reservoir, usually by a tube known as a “suction tube”.

The performance of the combination of injector and ejector is highly dependent on the correct positioning of these two components relative to each other, in terms of coaxiality and relative distance.

Conventionally, the injector and ejector are both mounted in the pump body. In this case, the coaxiality and distance between the injector and the ejector depend on the correct assembly of these two components in the pump body and on the geometry of the two separate housings provided in this pump body to accommodate these two parts. There are three reasons why the performance of a powder pump of this type can vary so widely: the precision of the machining of the housing for the injector in the pump body, the precision of the machining of the housing for the ejector in the pump body and the precision of the assembly of the injector and ejector in the pump body.

In addition, with this type of equipment, the suction chamber, in which the negative pressure caused by the expansion of the drive air is created, is built directly into the pump body, with a relatively high risk of clogging. This chamber must be carefully cleaned each time the powder pump injector or ejector is changed, or even between such changes.

It is also known from WO2020/141090A1 or US2020/047200A1 that part of an ejector of a Venturi powder pump is mounted in a front portion of an injector of this pump. In this pump, the injector is supplied with drive air from the side. The drive air has to turn a total of around 90° before being injected into an upstream part of the ejector, which creates a turbulent flow and makes the powder pump relatively inefficient at suction. In addition, the assembly of the injector in the body of the powder pump is potentially unbalanced, which can lead to misalignment of the injector outlet with respect to the ejector inlet, particularly as a result of the injector-ejector assembly turning about a longitudinal axis of the ejector, within the body of the powder pump.

Similar problems can arise with Venturi powder pumps used in other applications.

It is these disadvantages that the invention more particularly seeks to remedy by proposing a new powder pump in which the injector and the ejector are precisely positioned relative to each other and to the body of the powder pump.

### SUMMARY OF THE INVENTION

To this end, the invention relates to a Venturi powder pump comprising a pump body, a drive gas injector and an ejector for a mixture comprising a powdered product, in which:
the injector and ejector are mounted in the pump body when the powder pump is in the assembled configuration;
the pump body defines a duct for circulating a mixture comprising the powder product, upstream of the ejector;
the ejector is straight and extends along an ejector axis;
the injector and ejector are mounted directly on each other;
the injector is straight and extends along an injector axis;
the injector axis and the ejector axis are parallel and coincide when the powder pump is in the assembled configuration; and
the powder pump comprises means for indexing the position of the ejector within the pump body, in rotation about the ejector axis, which enable an inlet to a suction chamber to be aligned with the mixture circulation duct defined by the pump body.

The straight nature of the injector means that the flow of drive gas does not have to follow a circuitous path, resulting in greater stability in the supply of drive gas to the suction chamber. As the injector axis and the ejector axis are parallel when the powder pump is in the assembled configuration, the drive and mixing gas flows comprising the powdered product are parallel, in particular coaxial, which facilitates the Venturi effect. In addition, the indexing means ensure that the ejector is correctly positioned within the pump body, in particular to limit pressure drops and/or powder build-up at the inlet to a mixing chamber or the ejector.

According to advantageous but not mandatory aspects of the invention, such a powder pump may incorporate one or more of the following features, taken in any combination that is technically feasible:
The injector axis and the ejector axis coincide when the powder pump is in the assembled configuration.
The ejector is housed at least partly in a housing in the pump body, bearing against a surface of the pump body by means of a cone-on-cone interface centred on the ejector axis.
When the powder pump is in the assembled configuration, a nut screwed onto the pump body exerts a thrust force on the ejector, parallel to the ejector axis, in a direction in which the cone-on-cone interface is tightened.
A sleeve is fitted in the housing around the ejector. Together with the ejector, this sleeve defines a dilution air circulation volume which opens downstream around an outlet opening of the ejector and is provided with at least one radial passage for supplying the circulation volume with dilution air from a distribution chamber formed in the housing around the sleeve.
The injector and ejector are screwed together.
The injector and ejector are assembled together by a cylindrical fit.
The injector is made of metal and the ejector is made of synthetic material, preferably plastic.
The pump body defines a drive air circulation duct, upstream of the injector, and a dilution air circulation duct, upstream of the ejector. Connection fittings for supply hoses of the drive and dilution air circulation ducts, as well as at least part of the drive and dilution air circulation ducts, each extend along an axis parallel to a longitudinal axis of the mixture circulation duct defined by the pump body. The injector axis and the ejector axis are inclined at an angle other than 90°, preferably between 30 and 60°, with respect to the longitudinal axis of the mixture circulation duct defined by the pump body.
The indexing means comprise a relief formed on an external peripheral surface of the ejector and a complementary relief formed on a surface delimiting a housing for at least partial reception of the ejector in the pump body.

According to a second aspect, the invention relates to a powder coating installation comprising a coating reservoir, a drive gas source, a dilution gas source, a powder coating sprayer and a Venturi powder pump as mentioned above. The coating reservoir is connected to the mixture circulation duct defined by the pump body of the Venturi pump, the drive gas source is connected to a drive air inlet in the pump body, the dilution gas source is connected to a dilution air inlet in the pump body, and an ejector outlet is connected to the coating sprayer.

### BRIEF DESCRIPTION OF THE FIGURES

The invention will be better understood and other advantages thereof will become clearer in the light of the following description of a powder pump and a powder coating installation in accordance with its principle, given by way of example only and made with reference to the figures described below.

FIG. 1 is a schematic representation of the principle of a coating installation in accordance with the invention, incorporating a powder pump in accordance with the invention.

FIG. 2 shows, on two inserts A) and B), a cross-section of the powder pump of the installation shown in FIG. 1, according to plan II in FIG. 1, and a larger-scale detail view of detail B on insert A).

FIG. 3 is an exploded perspective view of the powder pump of FIG. 2, in which a body of the powder pump is shown in cross-section, in the same cross-sectional plane as in FIG. 2.

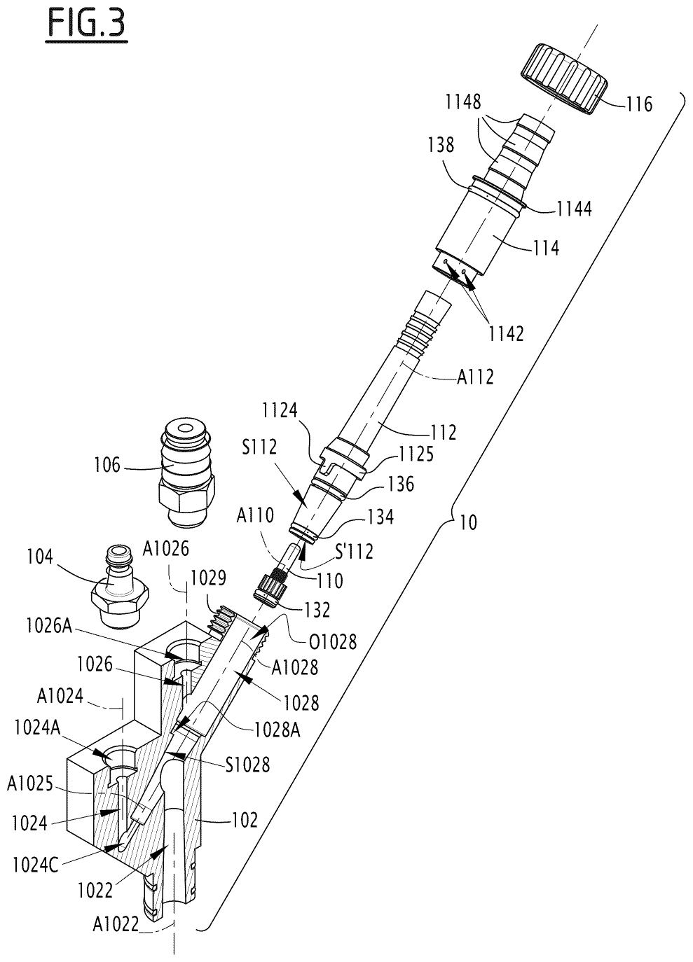

FIG. 4 shows an exploded view of the injector and ejector of the powder pump of FIGS. 2 and 3, with partial removal of the ejector at one of its inlets.

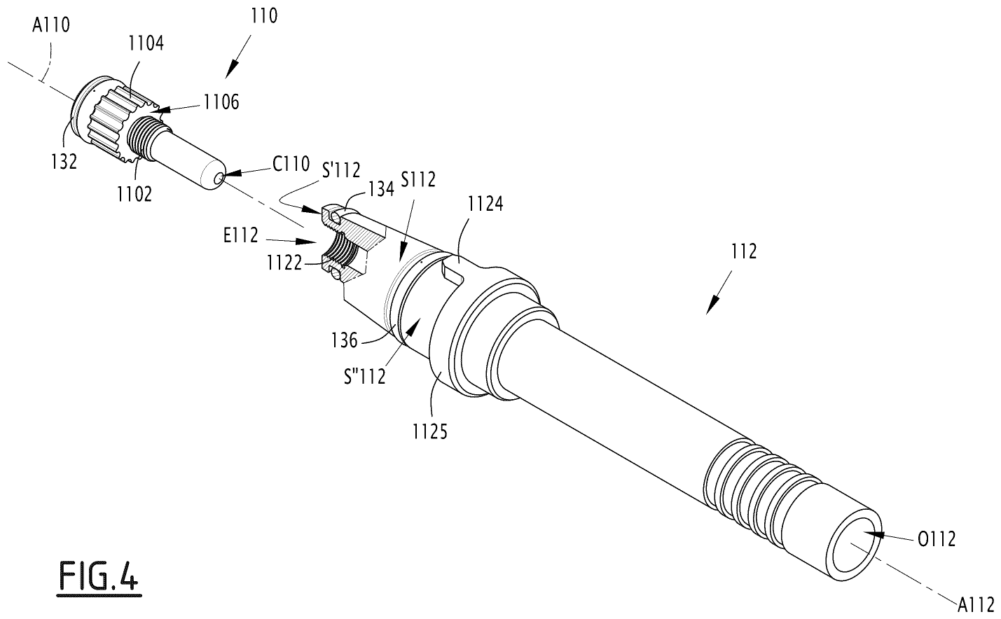

### DETAILED DESCRIPTION OF THE INVENTION

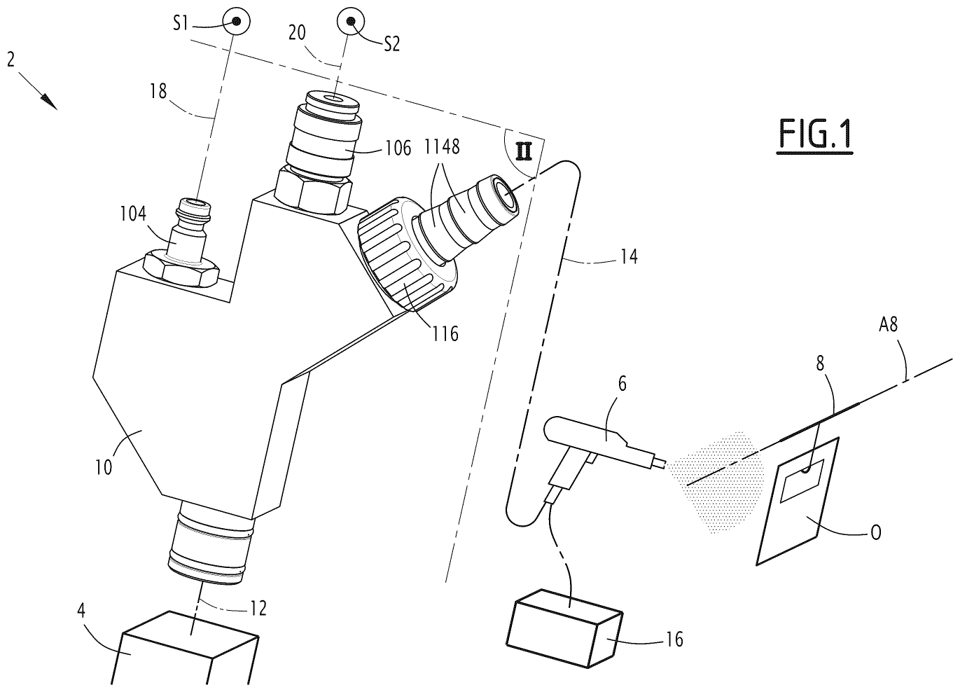

The installation 2 shown very schematically in FIG. 1 comprises a reservoir 4 for powder coating, also known as a “powder tank”, in which the coating is fluidised by means known per se and not shown, in particular a porous plate through which air flows.

The installation 2 further comprises a coating sprayer 6 designed to project the coating 6 onto objects O to be coated, which are moved by a conveyor 8 along a conveying axis A8.

The installation 2 further comprises a Venturi powder pump 10 which is connected to the reservoir 4 by a suction tube 12, this suction tube sometimes being referred to as a “suction tube” because it is a straight element which plunges into the reservoir 4.

Furthermore, the powder pump 10 is connected to the sprayer 6 by a flexible hose 14 for supplying this gun with a mixture of powder coating and gas.

The sprayer 6 is connected to a control unit which, in particular, enables electrostatic charging elements of the coating to be activated when the sprayer 6 is of the electrostatic type, these electrostatic charging means not being shown.

The sprayer 6 is shown in FIG. 1 as a manual gun for applying powder coating. Alternatively, not shown, the sprayer 6 can be an automatic sprayer mounted on a robot which moves it relative to the objects O to be coated, the robot being of the multi-axis or reciprocating type.

The powder pump 10 is supplied with powder coating drive gas from a gas source S1 and with dilution gas from a dilution gas source S2.

In practice, the drive and dilution gases are usually air.

Alternatively, other gases, such as nitrogen, can be used.

The pressures of the drive gas and the dilution gas are not necessarily the same.

In what follows, we consider the particular case where the drive gas and the dilution gas are air, it being specified that what follows is transposed to the case where the drive gas or the dilution gas are other gases.

The powder pump 10 comprises a pump body 102 which is advantageously made of metal, for example steel or aluminium.

The pump body 102 defines a first duct 1022 for circulating a mixture of air and powder coming from the reservoir 4 through the suction tube 12 and which extends along a longitudinal axis A1022 which may be referred to as the “suction axis”.

Advantageously, the longitudinal axis A1022 is vertical when the powder pump 10 is in use in the installation 2.

The pump body 102 also defines a second duct 1024 for circulating the drive air. A first fitting 104 is mounted on a mouth 1024A of the second duct 1024 and enables a hose 18 connected to the drive air source S1 to be connected. The mouth 1024A constitutes a drive air inlet into the pump body 102.

The pump body 102 also defines a third duct 1026 for circulating the drive air. A second fitting 106 is mounted on a mouth 1026A of the third duct 1026 and enables a hose 20 connected to the dilution air source S2 to be connected. The mouth 1026A constitutes a dilution air inlet into the pump body 102.

A1024 is the longitudinal axis of an upstream portion of the duct 1024. A1025 is the longitudinal axis of a downstream portion of the duct 1024. The axes A1024 and A1025 are not parallel, which corresponds to the fact that the duct 1024 forms a bend 1024C within the body 102.

A1026 is the straight longitudinal axis of duct 1026.

The axes A1022, A1024 and A1026 are parallel.

The pump body 102 also defines a housing 1028 which extends along a longitudinal axis A1028 inclined with respect to the axes A1022, A1024 and A1026 by an angle α different from 90°.

Advantageously, the angle α has a value between 30 and 60°, preferably equal to approximately 45°.

Advantageously, the axes A1025 and A1028 are parallel, preferably coincident.

The housing 1028 is configured to receive an injector 110, an ejector 112 and a sleeve 114.

The downstream portion 1025 of the duct 1024 opens into the bottom of the housing 1028.

Advantageously, the first duct 1022 is located, on the flow path of the coating, upstream of the ejector 112. Advantageously, the second duct 1024 is located, on the drive air flow path, upstream of the injector 110. Advantageously also, the third duct 1026 is located, on the dilution air flow path, upstream of the ejector 112.

The injector 110 is straight and extends along a longitudinal axis A110 which forms an axis of symmetry for this injector and which constitutes an injector axis.

When the injector 110 is installed in the housing 1028, the axes A110 and A1028 coincide.

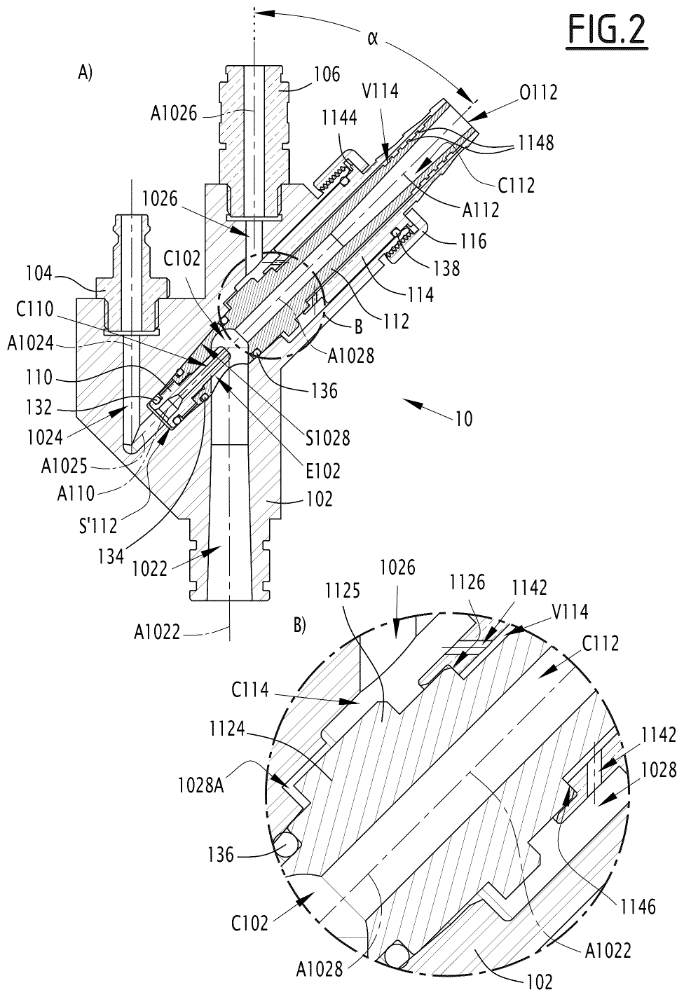

The injector 110 defines a channel C110 for the circulation of drive air into a suction chamber C102 defined by the ejector 112 and into which the injector 110 penetrates, as can be seen in insert A) of FIG. 2.

The channel C110 is straight and centred on the injector axis A110.

The ejector 112 is straight and extends along a longitudinal axis A112 which forms an axis of symmetry for this ejector and which constitutes an ejector axis.

The ejector 112 defines a channel C112 for circulation of a mixture of powder coating and air, this channel C112 being centred on the ejector axis A112. O112 is the outlet opening of the channel C112. The outlet opening O112 is opposite the suction chamber C102. It is connected to the sprayer 6 by the hose 14 in the operating configuration of the installation 2.

When the ejector 112 is installed in the housing 1028, the axes A112 and A1028 coincide.

Advantageously, when the injector 110 and the ejector 112 are in the mounted configuration within the housing 1028, the injector axis A110 and the ejector axis 112 are inclined by the angle α with respect to the axes A1022, A1024 and A1026.

In practice, the injector axis A110 and the ejector axis A112 coincide when the powder pump is in the assembled configuration 10.

The sleeve 114 is mounted around the ejector 112, defining with it an annular volume V114 for the circulation of dilution air. Radial to ejector axis A112, volume V114 is defined between the ejector 112 and sleeve 114. The volume V114 opens downstream around the outlet opening O112 of the ejector 112.

A distribution chamber C114 is provided within the housing 1028, around the elements 112 and 114. The distribution chamber 114 is supplied with dilution air from the source S2 through the duct 1026.

Radial passages 1142 pass radially through the sleeve 114 and connect the distribution chamber C114 and the circulation volume V114, allowing the dilution air to progress from the duct 1026 to the outlet of the volume V114, around the outlet opening O112.

In the assembled configuration of the Venturi pump 10, the injector 110 is completely received in the housing 1028, while the ejector 112 and the sleeve 114 are partially received in this housing and project outside the pump body 102, as can be seen in insert A) of FIG. 2.

A nut 116 is screwed onto an external thread 1029 of the pump body 102, formed around an outlet opening O1028 of the housing 1028 opposite the first and second ducts 1022 and 1024. When it is screwed onto the thread 1029, the nut 116 comes to bear on an external collar 1144 of the sleeve 114 which it pushes towards the bottom of the housing 1028, opposite the outlet opening O1028.

Furthermore, the sleeve 114 defines a shoulder 1146 which bears axially, in a direction parallel to the axis A1028, against a corresponding shoulder 1126 of the ejector 112, which makes it possible to transmit to the ejector 112 the thrust force exerted by the nut 116 on the collar 1144. The ejector 112 is thus pressed towards the bottom of the housing 1028.

Seals isolate the channels C110 and C112, as well as the circulation volume V114, from the outside of the pump body 102. These are a seal 132 carried by the injector 110, two seals 134 and 136, carried by the ejector 112 and which are located on either side of the suction chamber C102 along the ejector axis A112, and a seal 138 carried by the sleeve 114.

Reliefs 1148 for hooking the supply hose 14 are provided on the outside of the portion of the sleeve 114 which projects from the pump body 102. The external shape of the sleeve 114 can be described as a “Christmas tree fitting”.

A cone-to-cone interface is provided between the body 102 and the ejector 112.

More specifically, a frustoconical surface S1028, inside the body 102, delimits the housing 1028 near its base. This internal frustoconical surface S1028 is designed to receive an external frustoconical surface S112 of the ejector 112.

The internal frustoconical surface S1028 is centred on the axis A1028 and diverges towards the outlet opening O1028. The external frustoconical surface S112 is centred on the ejector axis A112 and diverges in the direction of the outlet opening O112.

The internal frustoconical surface S1028 is truncated at its intersection with the first duct 1022.

The cone-on-cone interface of surfaces S112 and S1028 allows precise centring of ejector axis A112 on axis A1028 and precise positioning of ejector 112 along axis 1028.

The nut 116 is used to exert a thrust force on the ejector 112 parallel to the ejector axis A112 in a direction in which the cone-on-cone interface between surfaces S112 and S1028 is tightened. This makes the positioning of the ejector 112 in the housing 1028 more reliable.

Furthermore, the injector 110 and ejector 112 are mounted directly on each other. Advantageously, the injector 110 is screwed into the ejector 112, opposite the outlet opening O112. To do this, the injector 110 is provided with an external thread 1102 which cooperates with a correspondingly shaped internal thread 1122 of the ejector 112, provided at its inlet E112.

The outer peripheral surface of the injector 110 is provided with grooves 1104 which facilitate its grip and the application of a screwing torque in the ejector 112 when the elements 110 and 112 are screwed together.

Alternatively, another type of relief can be used instead of the grooves 1104, for example knurling.

The elements 110 and 112 are screwed together until a shoulder 1106 of the injector 110 comes into abutment against an annular surface S′112 of the ejector 112 which surrounds the inlet E112, which ensures precise positioning of the injector 110, relative to the ejector 112 and the suction chamber C102, along the axis A1028.

To ensure that the angular orientation of the ejector 112 about the axis 1028 enables a fit without any surface discontinuities between the duct 1022 and the suction chamber C102, means for indexing the position of the ejector 112 within the pump body 102, in rotation about the ejector axis A112, are provided. These indexing means enable an inlet E102 of the suction chamber C102 to be aligned with the duct 1022.

These indexing means comprise a projecting relief, in this case a heel 1124, formed on an external peripheral surface S″112 of the ejector 112. The heel 124 extends, locally and with a relatively small angular extent, of the order of 5 to 10°, an external peripheral collar 1125 of the ejector 112.

Furthermore, a recessed relief, in this case a local extension 1028A of the housing 1028, is provided to receive the projecting relief 1124 when the surfaces S112 and S1028 are in surface contact with one another. Advantageously, the shape of the extension 1028 is complementary to that of the heel 1124. The engagement of the heel 1124 in the extension 1028A has the effect of fixing the angular position of the ejector 112 in rotation about the ejector axis A112 and the axis A1028 of the housing 1028, which ensures that the inlet E102 of the suction chamber C102 is correctly positioned with respect to the duct 1022. This minimises pressure losses and the risk of coating build-up at the inlet to the suction chamber C102.

In the example shown in the figures, the heel 1124 is completely received in the extension 1028A when the injector 110 and the ejector 112 are mounted and clamped in the housing 1028. Alternatively, only a portion of the heel 1124 is received in the extension 1028A.

According to a non-represented variant of the invention, a projecting relief is provided on the body 102 and a recessed relief is provided on the ejector 112, as means of indexing the position of the ejector 112 within the pump body 102, in rotation about the ejector axis A112.

The elements 110, 112 and 114 are reversibly mounted in housing 1028. Thus, when it is necessary to carry out a maintenance operation on the powder pump 10, the nut 116 can be unscrewed and the sub-assembly formed by the elements 110, 112 and 114 can be removed from the housing 112, before separating the sleeve 114 from the elements 110 and 112.

The elements 110 and 112 can then be unscrewed from each other and the element 112 can be changed when it is worn by the passage of the powder coating mixed with the drive air.

In this respect, the injector 110 is preferably made of metal, whereas the ejector 112 is preferably made of synthetic material, for example plastic such as high-density polyethylene or macromolecular polyethylene marketed for example under the brand name Polystone. Alternatively, other synthetic materials can be used for the ejector 112.

The injector is made of a material that is more resistant to abrasion than the material of the ejector 112 and its channel C110 allows air that is not loaded with powder to pass through, unlike channel C112 which allows the mixture of air and coating to pass through. In this way, the injector 110 has a longer service life than the ejector 112.

The value of the angle α, which is different from 90°, gives the powder pump 10 good compactness in a transverse direction perpendicular to the direction of the axis of suction of the coating into the reservoir 4, i.e. axis A1022.

According to an unrepresented variant of the invention, a powder pump according to the invention can be used in an installation other than a powder coating installation.

According to a non-represented variant of the invention, the injector 110 and the ejector 112 are mounted directly on each other by a cylindrical fit, for example with a press fit, without being screwed together.

Any feature described above for one embodiment or variant is applicable to the other embodiments and variants, insofar as this is technically possible.

1. A Venturi powder pump comprising a pump body, a drive gas injector and an ejector for a mixture comprising a powdered product, wherein:
the injector and the ejector are mounted in the pump body when the powder pump is in the assembled configuration;
the pump body defines a duct for circulating a mixture comprising the powder product, upstream of the ejector;
the ejector is straight and extends along an ejector axis;
the injector and the ejector are mounted directly on each other;
the injector is straight and extends along an injector axis;
the injector axis and the ejector axis coincide when the powder pump is in the assembled configuration; and
the powder pump comprises means for indexing the position of the ejector within the pump body, in rotation about the ejector axis, which make it possible to align an inlet of a suction chamber with the mixture circulation duct defined by the pump body.

2. The powder pump according to claim 1, wherein the injector axis and the ejector axis coincide when the powder pump is in the assembled configuration.

3. The powder pump according to claim 1, wherein the ejector is received at least partly in a housing of the pump body, bearing against a surface of this pump body by means of an interface of the cone-on-cone type, centred on the ejector axis.

4. The powder pump according to claim 3, wherein, when the powder pump is in the assembled configuration, a nut screwed onto the pump body exerts a thrust force on the ejector, parallel to the ejector axis, in a direction in which the cone-on-cone interface is tightened.

5. The powder pump according to claim 3, wherein:
a sleeve is mounted in the housing around the ejector;
the sleeve defines with the ejector a dilution air flow volume which opens downstream around an outlet opening of the ejector; and
the sleeve is provided with at least one radial passage for supplying the circulation volume with dilution air from a distribution chamber formed in the housing around the sleeve.

6. The powder pump according to claim 1, wherein the injector and the ejector are screwed together.

7. The powder pump according to claim 1, wherein the injector and the ejector are assembled together by a cylindrical fit.

8. The powder pump according to claim 1, wherein the injector is made of metal and the ejector is made of synthetic material, preferably plastic.

9. The powder pump according to claim 1, wherein:
the pump body defines a drive air circulation duct, upstream of the injector, and a dilution air circulation duct, upstream of the ejector;
fittings for connecting pipes supplying the drive and dilution air circulation ducts, as well as at least some of the drive and dilution air circulation ducts, each extend along an axis parallel to a longitudinal axis of the mixture circulation duct defined by the pump body; and
the injector axis and the ejector axis are inclined at an angle other than 90°, preferably between 30 and 60°, with respect to the longitudinal axis of the mixture circulation duct defined by the pump body.

10. The powder pump according to claim 1, wherein the indexing means comprise a relief formed on an external peripheral surface of the ejector and a complementary relief formed on a surface delimiting a housing for at least partial reception of the ejector in the pump body.

11. A powder coating installation comprising a coating reservoir, a source of drive gas, a source of dilution gas, a powder coating sprayer and the Venturi powder pump according to claim 1, wherein:
the coating reservoir is connected to the mixture circulation duct defined by the pump body of the Venturi pump;
the source of drive gas is connected to a drive air inlet in the pump body;
the dilution gas source is connected to a dilution air inlet in the pump body; and
an outlet of the ejector is connected to the coating sprayer.
